(19) United States
(12) Patent Application Publication
(10) Pub. No.: US 2004/0139006 A1
(43) Pub. Date: Jul. 15, 2004

(54) Method for repayment of elevator investment costs

(76) Inventor: Simo Makimattila, Espoo (FI)

Correspondence Address: BIRCH STEWART KOLASCH & BIRCH, PO BOX 747, FALLS CHURCH, VA, 22040-0747, US

(21) Appl. No.: 10/743,744

(22) Filed: Dec. 24, 2003

Related U.S. Application Data
(63) Continuation of application No. PCT/FI02/00507, filed on Jun. 11, 2002.

(30) Foreign Application Priority Data
Jun. 28, 2001 (FI) 20011393

(51) Int. Cl. G06F 17/60

(52) U.S. Cl. 705/39

(57) ABSTRACT

The invention relates to a method for repayment of the investment costs of an elevator on the basis of personal identification of the passenger, by providing the aforesaid passenger with a card comprising the personal data of the aforesaid passenger, on the basis of which card a remote reader installed in connection with the elevator identifies the passenger.

The present invention relates to a method as defined in the preamble of claim 1 for repayment of elevator investment costs on the basis of passenger identification.

The method of the present invention relates to installing an elevator in a building where no elevator has been installed before. The problem is the technical solution and placement of the elevator in the existing structures so that the investment and operation costs of the elevator could be financed.

A solution generally applied to solve the parameter is one in which the shareholders of the housing corporation of the building pay the entire elevator investment as a single payment or in installments included in the so-called maintenance charge. In this case it is generally not possible to take into account who uses the elevator and how much each shareholder of the housing corporation uses it. In other words, even those shareholders of the housing corporation who for one reason or another do not often use the elevator have to contribute to repayment of the elevator investment costs.

Prior art is described in JP specification abstract 11060084 (B66B 1/14), which discloses an elevator controller based on an elevator user identification function. This controller comprises a card reader placed inside the elevator car. The card reader identifies the user entering the elevator car and accepts a registered destination call. Use of the elevator car is not allowed until a registered destination call is accepted on the basis of identification. After the identification, a call registering lamp inside the elevator car shows the floor given by the user. In addition, various types of elevator systems subject to charge are commonly used.

The problem with prior-art solutions is that the elevator investment costs can not be amortized and paid on the basis of intensity of elevator use and identification of passengers using the elevator.

In applications based on intelligent cards, the problem is that the remote reading function is difficult to implement due to the large numbers of passengers involved, because in this case the distance requirement for non-contact reading is difficult to meet.

The object of the present invention is to eliminate the disadvantages encountered in the above-mentioned prior-art solutions.

In precise terms, the method of the invention for repayment of elevator investment costs on the basis of personal identification of the passenger is characterized by what is presented in the characterization part of claim 1.

By applying the method of the invention, significant advantages are achieved as compared with prior art solutions.

An elevator according to the present invention is better applicable for satisfying the requirements of different user groups. In addition, it is possible to implement the sharing of elevator investment costs according to elevator use on an elevator passenger-specific basis. Likewise, it is possible to define an appropriate basis of compensation for the use of the elevator. In particular, the method can be developed further so that, by showing the same intelligent card or ticket card, a person can move and travel even on other means of transport, such as trains, ships, airplanes, street cars, etc.

In particular, by applying the method of the present invention for using an elevator, it is possible to shorten the repayment time of the elevator investment.

In addition, the above-mentioned elevator is better suited to satisfy the requirements of different types of user groups. In a building there are always people who use the elevator to different extents. This may be due e.g. to travels or the dwelling being located on a low floor. Thus, the present invention makes it possible to achieve equitable repayment of elevator investment costs on a passenger and resident specific basis.

According to a preferred embodiment of the invention, the aim is to cover the investment costs of a new elevator to be installed in a building entirely on the basis of elevator use. The invention consists of a method for repayment of elevator investment costs on the basis of passenger identification. This is implemented by providing the aforesaid passenger with a card comprising the personal data of the aforesaid passenger, by which card a remote reader installed in connection with the elevator identifies the aforesaid passenger who wants to enter the elevator.

According to the invention, each passenger of the aforesaid elevator is charged for using the elevator on the basis of the number of times of use via the aforesaid card comprising the personal data of the passenger wanting to enter the elevator, in such manner that the investment costs of the aforesaid elevator are repaid.

In addition, according to an embodiment of the method of the invention, the aforesaid intelligent card gives the passenger access to the elevator. The intelligent card also contains storable data. On an intelligent card like this, it is possible to store in its electronic memory a sum of money corresponding to a given payment made, which sum is decremented by the card reader each time the person travels on the elevator. The intelligent card would always have updated account balance information.

According to the invention, the passengers are charged different sums for the use of the aforesaid elevator depending on the destination floor, which is advantageous when the passenger uses destination calls. Thus, for example, traveling to a higher floor would obviously be more expensive to the passenger than traveling to a lower floor. Likewise, according to an embodiment of the invention, the degrees of mobility of user groups of different ages relating to elevator use are taken into account. The aforesaid mobility refers to the ability of a person to move and to the impairment of said ability e.g. due to age or illness.

The intelligent card can be so implemented that the charge to the elevator passenger can also be made using different currency units. Therefore, a foreign passenger will not have to exchange money in order to travel on the elevator if he uses an intelligent card like this.

In addition, according to a preferred embodiment of the invention, this card identifying the passenger wanting to enter the elevator is preferably a remotely readable ticket card of the size of a credit card, and a remote reader installed in the elevator identifies the passenger entering the elevator by the ticket card held by the passenger.

This aforesaid ticket card may be e.g. optically readable. When a passenger is entering the elevator, he shows the card to the card reader, whereupon the data loaded or stored on the card are transferred to the elevator control system.

The information stored on the aforesaid intelligent card and ticket card includes e.g. the person's name, user identifier and information regarding travel rights, such as e.g. the floors to which the person may travel on the elevator.

Other cards applicable in the method of the invention for identifying the passenger wanting to enter the elevator include identity cards, such as personal identification card, health insurance card, student card, driver's license and party membership card. The data regarding the passenger wanting to enter the elevator and identified on the basis of these cards are recorded in the elevator control system.

On the other hand, according to an embodiment of the invention, the personal identification may be based on several different cards that are readable either by optical, magnetic or electric means. Moreover, the personal identification may be based on several cards simultaneously. Such a situation may arise when the identity of the person wanting to enter the elevator is to be verified with absolute reliability by means of several cards. Such a situation might occur e.g. in an elevator system intended for use by a given political student organization, in which case the remote reader will have to read data both from identity cards, student cards and party membership cards.

Thus, personal identification as described above may be based on several different cards that are readable by either optical, magnetic or electric means.

On the other hand, the means identifying the elevator user need not be of a card-like form at all; instead, it may also consist of an identifying object that is easy to be carried by the elevator passenger. Such an object might be e.g. an intelligent sticker or intelligent wristband or a bluetooth or equivalent.

According to the invention, the remote reader installed in the elevator for reading a card containing the personal data of the passenger wanting to enter the elevator is mounted in the first place in connection with a call button, in which case the aforesaid passenger can enter a call by showing the aforesaid card, whereupon the elevator control system will issue a call corresponding to the data on the card. On the other hand, the person wanting to enter the elevator can enter a call by showing the card and issuing a call by pressing an actual call button.

This aforesaid remote reader can be installed on an elevator landing, in which case a landing call is given by showing the card, on the basis of which the control system will bring the elevator car to the corresponding floor.

According to the invention, all data are updated to the maintainer of the elevator via the remote reader installed on the elevator. Thus, an interest group, e.g. a social authority, can receive information regarding the aforesaid elevator. This is advantageous e.g. in a residential building intended for old or handicapped people.

Likewise, the aforesaid remote reader registers the times of elevator use by each passenger separately. Therefore, from this information regarding the times of elevator use by each passenger, it will be easy to maintain statistics by collecting the data relating to the times of elevator use by each passenger using the elevator from the elevator group control level and from the group control computer.

The aforesaid remote reader also registers the floors of departure and arrival of each passenger separately. Therefore, it is possible to collect reliable statistical data about use of the elevator on the basis of intensity of use, which data can be utilized e.g. in allocating the billing for the use of the elevator, in the planning of passenger-specific discounts and in access surveillance.

In the foregoing, the invention has been described by way of example while different embodiments of the invention are possible within the scope of the inventive idea defined in the claims.

1. Method for repayment of the investment costs of an elevator on the basis of personal identification of a passenger wanting to enter the elevator, by providing the aforesaid passenger with a card comprising the personal data of the aforesaid passenger, on the basis of which card a remote reader installed in connection with the elevator identifies the passenger, characterized in that each passenger of the aforesaid elevator is charged via the aforesaid card for using the elevator on the basis of the number of times of use in such manner that the investment costs of the aforesaid elevator are repaid.

2. Method according to claim 1, characterized in that the card comprising the personal data of the aforesaid passenger is an intelligent card, which is used to give the passenger access to the elevator.

3. Method according to claim 1, characterized in that the card comprising the personal data of the aforesaid passenger is a ticket card, which is used to give the passenger access to the elevator.

4. Method according to claim 1, characterized in that the card comprising the personal data of the aforesaid passenger is a identity card or a personal identification card or a health insurance card or a student card or a driver's license or a party membership card.

5. Method according to claim 2 or 3 or 4, characterized in that the personal identification of the aforesaid passenger is based on several cards mentioned above and/or the personal identification of the aforesaid passenger may be based simultaneously on several cards mentioned above.

6. Method according to any one of the preceding claims, characterized in that the personal identification cards of the aforesaid passenger are read either by optical, magnetic or electric means.

7. Method according to claim 1, characterized in that the passengers are charged different sums for the use of the aforesaid elevator depending on the destination floor.

8. Method according to claim 1, characterized in that statistical data can be collected regarding the use of the aforesaid elevator, based on intensity of use.

9. Method according to any one of the preceding claims, characterized in that a remote reader is installed in the aforesaid elevator to allow the passenger to be identified by means of the aforesaid card comprising the personal data of the passenger.

10. Method according to claim 9, characterized in that the times of use of the elevator by the passenger are registered separately for each passenger by means of the aforesaid remote reader installed in the elevator.

11. Method according to claim 10, characterized in that the remote reader installed in the aforesaid elevator is mounted primarily in connection with a call button, allowing the aforesaid passenger to give a call by showing the aforesaid card, whereupon the elevator control system issues a call corresponding to the data on the card.

12. Method according to any one of the preceding claims, characterized in that the degrees of mobility of user groups of different ages are taken into account.

13. Method according to claim 1, characterized in that, by showing the aforesaid intelligent card or ticket card, a person can travel even on other means of transport, such as trains, ships, airplanes, street cars, etc.
